(19) United States
(12) Patent Application Publication
(10) Pub. No.: US 2011/0016494 A1
(43) Pub. Date: Jan. 20, 2011

(54) Method and Apparatus to Facilitate Viewing Television on a Mobile Device

(76) Inventor: Michael LINHARDT, Forest Park, IL (US)

Correspondence Address: BEEM PATENT LAW FIRM, 53 W. JACKSON BLVD., SUITE 1352, CHICAGO, IL, 60604-3787, US

(21) Appl. No.: 12/837,841

(22) Filed: Jul. 16, 2010

Related U.S. Application Data
(60) Provisional application No. 61/226,052, filed on Jul. 16, 2009.

(51) Int. Cl. H04N 7/16

(52) U.S. Cl. 725/62

(57) ABSTRACT

An accessory to provide at least one of television and video streams to a mobile device is disclosed, comprising a circuit board having a semiconductor chipset, a tuner chipset and a host processor; a battery; and a connector capable of attaching the circuit board to a connector of the mobile device. Also, a method of viewing at least one of television and videos on a mobile device is described. The method includes detecting a digital television signal with a tuner chipset; transmitting a signal to a semiconductor chipset; demodulating and communicating a signal to a host processor; and communicating a signal to a mobile device for viewing.

### CROSS-REFERENCE TO RELATED APPLICATIONS

The present application claims benefit of priority of U.S. Provisional Application No. 61/226,052, filed on Jul. 16, 2009.

### BACKGROUND

1. Field of the Invention

The present invention is directed to a novel method and apparatus to facilitate viewing broadcast video and audio signals such as ATSC-MH television on a mobile device, such as a cell phone.

2. Description of the Related Art

On Jun. 12, 2009, the United States television (TV) broadcasting network transitioned from Analog NTSC to Digital ATSC programming, as mandated by the Federal Government.

Realizing the potential benefits such as safety uses, advertising revenue, and overall profitability, approximately 880 local and regional U.S. television stations agreed to allocate a portion of the ATSC broadcast spectrum to mobile devices and create a mobile television market.

The new broadcast signal is called Mobile Digital Television (Mobile DTV) (or ATSC-MH, which is Advanced Television Systems Committee-Mobile Handset) and may be used for mobile devices. Mobile DTV may stream live shows or programming, such as the local news, sporting events and/or entertainment programs. In other words, Mobile DTV makes local, digital broadcast TV portable. With Mobile DTV, users can tune in to live, local TV programming.

What is needed is a reasonably priced external accessory to be used with mobile devices that enables a user to stream and/or watch live, digital television or a video stream on a mobile device.

### BRIEF SUMMARY OF THE INVENTION

In one aspect, an accessory to provide at least one of television and video streams to a mobile device is disclosed. The device includes a circuit board having a semiconductor chipset, a tuner chipset and a host processor; a battery; and a connector capable of attaching the circuit board to a connector of the mobile device. In one embodiment, the television stream includes at least one of audio and video streams.

In another aspect, a method of viewing at least one of television and videos on a mobile device is described. The method includes detecting a digital television signal with a tuner chipset; transmitting a signal to a semiconductor chipset; demodulating and communicating a signal to a host processor; and communicating a signal to a mobile device for viewing.

### BRIEF DESCRIPTION OF THE DRAWINGS

FIG. 1 is a perspective view of an exemplary embodiment of the invention in use.

FIG. 2 is a perspective view of an exemplary embodiment of the invention showing the 30-pin connector in use.

FIG. 3 is an exploded view of an exemplary embodiment of the invention.

FIG. 4 is a flowchart of the accessory hardware.

FIG. 5 is a diagram of framework for software to be used with the accessory.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention generally provides an accessory or dongle or invention 10 for a mobile device 26, such as a certain cell phone, smart phone, laptop computer, portable digital video disc (DVD) player, car stereo, and/or global positioning system (GPS), to enable a user to watch television (including audio and/or video) or video, such as Mobile DTV, on mobile device 26. As shown in FIG. 1, an exemplary device or cell phone 26 to which accessory 10 may be attached is the iPHONE® manufactured by APPLE®.

One advantage of the external accessory hardware device of the accessory or dongle or invention 10 is that the user can easily attach it to the mobile device or phone 26.

1. Accessory 10

In one embodiment, shown in FIG. 1, accessory 10 enables the user to view digital television on accessory or cell phone 26. For example, accessory 10 may enable the user to view ATSC-MH television, i.e., a type of real-time digital television, on a mobile device 26. ATSC-MH is a backwards-compatible transmission system to reach viewers on the move via broadcast DTV (digital) transmissions.

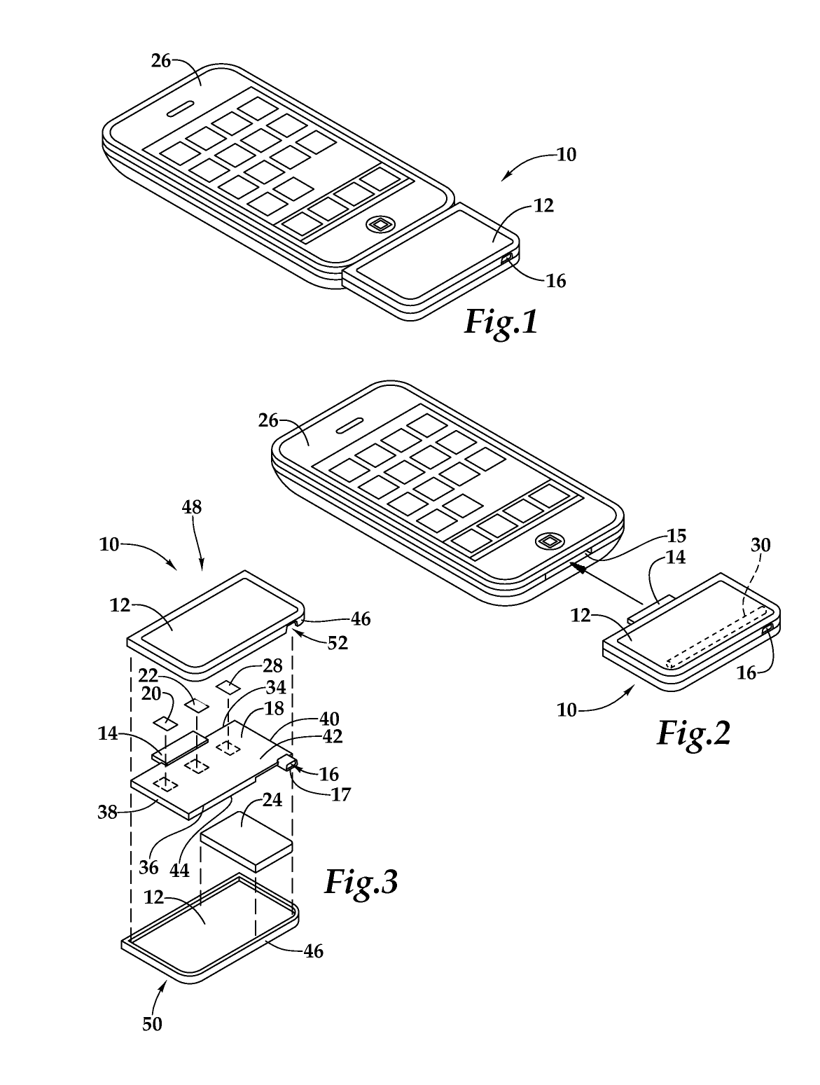

As shown in FIG. 3, embodiments of the present accessory or dongle or invention 10 may include at least one of a circuit board 18 housing an ATSC-MH semiconductor or chipset 20; an RF tuner chip 22 that may be designed to communicate with the ATSC-MH signal; and/or a male connector 14, such as a 30-pin male connector, that attaches the circuit board 18 to a female connector 15, such as a 30-pin female connector, of the device or cell phone or iPHONE® 26, a dock or port 16, such as a mini-USB or a micro-USB port; a battery 24; a housing or container 12; a processor or host processor 28; and/or an antenna 30, which is shown in FIG. 2. The circuit board 18 together with its components and the battery may be housed in a housing or container 12 that is preferably plastic.

At a system level, in one embodiment, the accessory hardware may include at least one semiconductor chip 20, such as the LG2160, at least one associated tuner integrated chip 22, an authentication co-processor 32, and a host processor 28 with at least one (1) USB interface and at least two (2) I²C (inter-integrated circuit) interface. An I²C interface may be a multi-master serial single-ended computer bus that is used to attach low-speed peripherals to a device, such as a motherboard, embedded system, or cell phone.

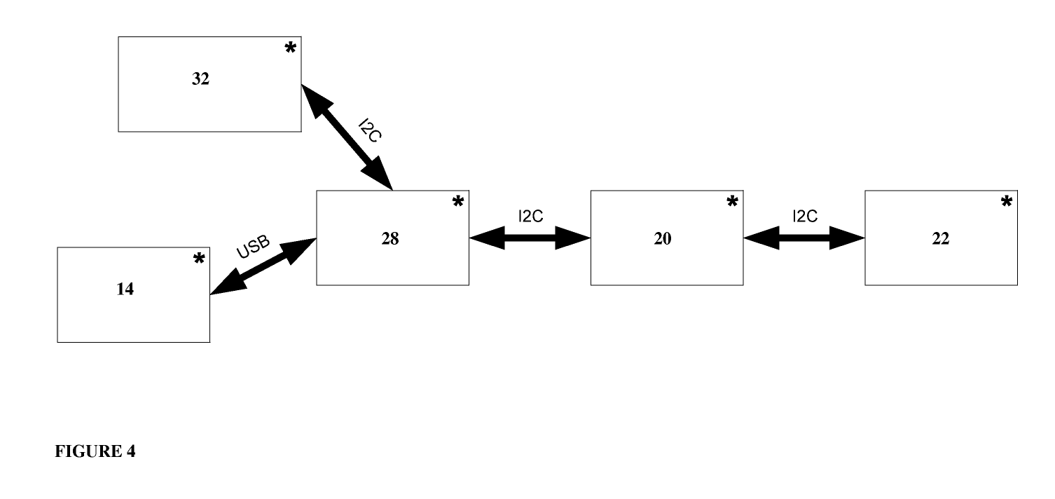

In one embodiment, the accessory hardware may be connected as illustrated in FIG. 4.

1.1 Circuit Board 18

As shown in FIG. 3, the circuit board 18 is designed and custom manufactured with a predetermined number of openings or slots to accommodate and/or electrically connect electronic components, for example, a specific ATSC-MH chipset 20, RF tuner chip 22 and/or host processor 28, using conductive pathways, tracks or signal traces.

The conducting layers of circuit board 18 may be manufactured of thin copper foil or other conductive materials. Additionally, in one embodiment, circuit board 18 may be substantially rectangular and may include a top edge 34, an opposing bottom edge 36 and two side edges 38 and 40 extending between edges 34 and 36. Further, in one embodiment, circuit board 18 may include an upper surface 42 and a lower surface 44. Circuit board 18 may have a length defined along top and bottom edges 34 and 36 between about 0.5″ and about 4″, preferably between about 1″ and about 3″, and in one embodiment, about 2″, and further may have a width defined along side edges 38 and 40 between about 0.25″ and about 2″ wide, preferably between about 0.5″ and about 1.5″ wide, and in one embodiment, about 1″ wide, and also may have a thickness defined between surfaces 42 and 44 between about 0.1″ and about 0.75″, preferably between about 0.25″ and about 0.5″, and in one embodiment, about 0.3″. In one embodiment, circuit board 18 has a length that is about the width of mobile device 26, circuit board 18 has a width that is about ⅓ or less than ⅓ the height of mobile device 26, and/or circuit board 18 has a thickness that is thinner than the thickness of mobile device 26. In an alternative embodiment, circuit board 18 has a length that no longer than the width of mobile device 26.

Different circuit boards can be created for use with a variety of different enclosures to accomplish the same goal. Additionally, the same technology configuration of device 10 can be used to create different accessories for different devices or cell phones. Alternatively, the same technology configuration of device 10 can be incorporated internally into mobile device 26.

1.2 Tuner Chip 22

Continuing with FIG. 3, accessory 10 may include tuner chip or tuner chipset or tuner integrated circuit (IC) 22 that may be configured to connect and/or couple to circuit board 18. In one embodiment, tuner chip 22 is a radio frequency (RF) tuner chip 22 with at least one I²C interface. In another embodiment, tuner chip 22 may be an ADI, an I²C ATCH-MH compatible tuner, and/or any other suitable tuner IC.

Chip 22 may be designed to receive an ATSC-MH signal and/or detect RF signals, usually of low amplitude, and amplify and convert the signals to a form suitable for further processing.

1.3 Semiconductor Chip or Chipset 20

Also as shown in FIG. 3, accessory 10 may include semiconductor chip or chipset 20 that also may be configured to connect and/or couple to circuit board 18. In one embodiment, semiconductor 20 may be compatible with and capable of communicating with tuner chip 22. In one embodiment, semiconductor chip 20 is an ATSC mobile television semiconductor chip, which may perform as a mini-processor providing some power. Some chipsets 20 that provide power may not have enough power to move television packets to the phone, and, in such an embodiment, an additional processor may be necessary to provide additional power.

An IP packet may be a basic data chunk that may be sent over the Internet. Data may be partitioned into IP packets on the sending computer or device and may be reassembled on the receiving device or computer.

In one embodiment, semiconductor chip 20 may provide mobile demodulating and equalization functions and may output IP packet streams that enable audio and/or video decoding in receivers, chipsets, processors or other such components that are compatible with the ATSC Mobile DTV standard. Such a semiconductor chip 20 may feature an automatic power-saving mode to maximize battery life for mobile device 26.

Semiconductor chip 20 may be commercially available and may be obtained by the manufacturer. For example, the ATSC semiconductor chip 20 may be an LG2160 or LG2161.

In an alternative embodiment, accessory 10 may operate and function without semiconductor chip 20.

1.4 Combination of Tuner Chip 22 and Semiconductor Chip 20

In an alternative embodiment, rather than accessory 10 and/or circuit board 18 including both tuner chip 22 and semiconductor chip 20, accessory 10 and/or circuit board 18 may include one receiver chip (not shown), such as the commercially available semiconductor chip or chip LG2161R (which includes both a tuner chip and semiconductor chip).

1.5 Processor 28

Continuing with FIG. 3, accessory 10 may include a host processor or processor 28 that may be configured to couple to circuit board 18. Processor 28 may be responsible for packaging semiconductor chip 20 user datagram protocol (UDP) packets into a universal serial bus based (USB-based) port 14 to establish communication therebetween. Processor 28 may include at least one integrated I²C interface and at least one USB interface, which may be a USB high-speed interface. In one embodiment, the at least one integrated I²C interface is configured to communicate with semiconductor chip 20 and the at least one USB high-speed interface is configured to communicate with connector 14.

Additionally, processor 28 may supply enough power to move the TV packets between accessory 10 and mobile device 26. In one embodiment, processor 28 supplies power to supplement the power of semiconductor chip 20 to facilitate operation of accessory 10.

In one embodiment, processor 28 uses a platform, such as the AT91SAM9M10 ARM-based processor, that may run at about 400 MHz and may run many Linux/ARM distributions natively, in addition to having integrated I²C and USB High-speed interfaces. Alternatively, processor 28 may run at any speed suitable to communicate with other components of accessory 10. Processor 28 may run between about 100 MHz and about 1 GHz, preferably between about 200 MHz and about 500 MHz, and in one embodiment, about 400 MHz.

Processor 28 should provide plenty of head-room for caching and encapsulating data as needed. In one embodiment, processor 28 should provide head-room for caching and encapsulating data as needed into the APPLE®-compatible accessory protocol.

In one embodiment, processor 28 includes at least two I²C interfaces and at least one USB interface. For example, as shown in FIG. 4, processor 28 includes two I²C interfaces when accessory 10 includes an APPLE® authentication co-processor (discussed below), such that one I²C interface is configured to communicate with semiconductor chip 20, one I²C interface is configured to communicate with the APPLE® authentication co-processor, and one USB interface is configured to communicate with connector 14.

In an alternative embodiment, accessory 10 may operate and function without host processor 28.

1.6 Optional Authentication Co-Processor 32

Continuing with FIG. 4, accessory 10 may include an optional co-processor 32. For example, when mobile device 26 is an APPLE® device, accessory 10 may include an optional APPLE® authentication co-processor 32, such that co-processor 32 is configured to authenticate accessory 10 for use as an APPLE® accessory, such as an APPLE® iPHONE® accessory. Such an APPLE® authentication co-processor is commercially available and can be obtained by the manufacturer.

Additionally, optional co-processor 32 may be configured to communicate with host processor 28 via at least one I²C interface.

Alternatively, accessory 10 may not include optional co-processor 32.

1.7 Connector 14

As shown in FIGS. 3 and 4, accessory 10 may include a dock interface or connector 14 that is configured to attach circuit board 18 to device 26. In one embodiment, connector 14 is a male connector 14 that is configured to be compatible and/or communicate and/or interface with connector 15 of device 26 and male connector 14 may have any suitable configuration.

In one embodiment, connector 14 is USB-based. For example, connector 14 may be a mini-USB connector or a micro-USB connector that is compatible with the mini-USB or micro-USB port of a device 26, such as a smart phone like the BLACKBERRY® or those running the WINDOWS MOBILE™ or ANDROID™ operating systems.

In another embodiment, the accessory or dongle or invention 10 comprises a 30-pin male connector 14, which is compatible with the complementary female 30-pin connector 15 of an APPLE® device, such as an APPLE® iPHONE®. Such a 30-pin male connector may be a USB-based interface.

In a further embodiment, accessory 10 may operate and function without connector 14. For example, accessory 10 may operate and function using WIFI (wireless fidelity) communications and/or Bluetooth communications, such that the signal communicated from host processor 28 is transmitted to mobile device 26 via WIFI and/or Bluetooth. Accessory 10 may use a wireless modem (wifi) to stream tv and/or video signal packets from accessory 10 to a wifi-enabled device. Similarly, accessory 10 may use a Bluetooth modem to stream tv and/or video signal packets from accessory 10 to a Bluetooth-enabled device

A WIFI modem transmits and receives using radio wave signals to and from another WIFI modem. Such signals are sent and received by wireless modems (hardware) that exist between two devices that connect to each other using the unlicensed IEEE-802.11 protocol at the about 2.4 GHZ Radio Frequency spectrum band. In one embodiment, host processor 28 may send the packets to the WIFI modem instead of connector 14, or a USB connection, and the WIFI modem may transmit the packets to be received by the device's WIFI modem. A software client, such as a version of an Aircast Mobile application, may detect the packets received by the WIFI modem of device 26, and in cooperation with the device's processor, may move the received packets into the device cache memory to be accessed later by the software application.

Bluetooth modems work similar to WIFI modems to transmit video over Bluetooth signals from accessory 10 to device 26 using each device's Bluetooth modem as long as each device's Bluetooth software stack supports the VDP (Video Distribution Profile) Bluetooth profile. This specific profile may allow support to send video in the H.263 video format over the Bluetooth transmission. In one embodiment, software on the hardware accessory 10 would convert the H.264 video packets into H.263 video packets before they were transmitted by the Bluetooth modem to device 26. Software client, such as the AirCast software application, on device 26 would then be configured to playback H.263 video content that was transmitted.

1.8 Female Connector 15

Continuing with FIGS. 3 and 4, device 26 may include a device interface or connector 15 configured to communicate with and/or interface with connector 14 of accessory 10. Connector 15 may have any suitable configuration configured to interface and/or receive connector 14. For example, connector 15 may be a mini-USB connector or a micro USB connector. In another embodiment, where device 26 is an APPLE® device, such as an APPLE® iPHONE®, connector 15 is a 30-pin female connector, that is configured to receive connector 14.

1.9 Battery 24

In one embodiment, accessory 10 includes battery 24, such that battery 24 may facilitate powering the accessory components, including but not limited to the ATSC-MH chipset 20 and/or the RF tuner chip 22 on the circuit board 18 to which it is connected.

In one embodiment, battery 24 may have a current load, while everything is active, between about 10 mA and 1000 mA, preferably between about 300 mA and 500 mA, and in one embodiment, about 400 mA. In one embodiment, it may be possible to pack about 2000 mAh worth of LiPo capacity into accessory 10 without impacting the size of accessory 10 to supply approximately 5 hours of active time.

Battery 24 also may function as an additional power source to device 26, when user is using or not using accessory 10 to watch television on device 26.

In an alternative embodiment, accessory 10 does not include battery 24 but may be powered, e.g., by battery in device 26.

1.10 Port 16

As shown in FIGS. 2 and 3, accessory 10 preferably includes a port 16 that may be available from the exterior of the enclosure 12 (discussed herein below) to facilitate charging battery 24 and/or battery in device 26. In one embodiment, circuit board 18 comprises or is coupled to port 16, such that port 16 may extend a distance outward from circuit board 18 to facilitate coupling port 16 to another component (not shown). Port 16 may be a mini-USB port or a micro-USB port. Also, in one embodiment, port 16 may include an open end 17. Alternatively, port 16 may be any suitable port that facilitates charging battery 24. Port 16 may be configured to couple to operate with an AC adapter to be plugged into the wall for charging. Alternatively, port 16 may be configured to couple accessory 10 to another device, such as a laptop or desktop computer, to be charged via that device.

In one embodiment of accessory 10, port 16 and connector 14 may be coupled to opposing sides of circuit board 18 for ease of use of accessory 10. For example, connector 14 may be positioned proximate or along top edge 34 of circuit board 18, wherein port 16 may be positioned proximate or along bottom edge 36 of circuit board 18.

In an alternative embodiment, accessory 10 may operate and function without port 16.

1.11 Housing or Container 12

In one embodiment, accessory 10 may have a housing or enclosure or container 12 that is sized to house and protect the components of accessory 10, such as circuit board 18, connector 14, chip set 20, tuner 22, processor 28, battery 24 and/or port 16.

Housing 12 may be fabricated from any suitable material, such as plastic. In the exemplary embodiment of the invention, the circuit board 18 together with the entire plastic enclosure 12 may be connected to the device or cell phone or iPHONE® 26 by attaching the 30-pin male connector of the device 10 to the complementary connector of the device or cell phone or iPHONE™ 26.

In one embodiment, housing 12 is fabricated from two substantially rectangular portions, an upper portion 48 configured to cover circuit board upper surface 42 and a lower portion 50 configured to cover circuit board lower surface 44, each with a lip 46, such that portions 48 and 50 are configured to snap, interface or couple together via lips 46 and such that a space between portions 48 and 50 is created to accommodate and/or protect circuit board 18 and other components of accessory 10.

Lip 46 of portion 48 may include an indentation 52 that may be contoured similar to the shape of port 16, such that port 16 may abut upper portion 48. When portions 48 and 50 are coupled together, indentation 52 creates an opening, such that port 16 is accessible through opening 17. Additionally, in one embodiment, housing 12 may include an opening such that connector 14 may extend outward a predetermined distance from housing 12 to enable facilitate interfacing connectors 14 and 15. In one embodiment, port opening 17 and connector opening are on opposing edges. For example, port opening 17 may be formed along a bottom edge of housing 12, such that the bottom edge is configured to align with bottom edge 36 of circuit board 18, and the connector opening may be formed along a top edge of housing 12, such that the top edge is configured to align with top edge 34 of circuit board 18.

In an alternative embodiment, accessory 10 may operate and function without housing 12. For example, accessory 10 may be incorporated within device 26, that may negate the need for housing 12.

1.12 Antenna 30

As shown in FIG. 2, accessory 10 may include an antenna 30 configured to improve and facilitate the transmission and/or receipt of the television frequency signals to tuner 22 and/or accessory 10. TV signals travel quickly with low transmission loss; however, sometimes some of the TV signals are absorbed when moving through more insulative materials, such as concrete walls or rock. As such, in one embodiment, antenna 30 is configured to improve the reception of the television signals.

Antenna 30 may be coupled to tuner 22. Antenna 30 may be connected to housing 12 and/or tuner 22 at a contact point such that antenna 30 can pivot and rotate at the contact point. In one embodiment, antenna 30 may be configured to telescope such that antenna 30 may be adjusted between a collapsed position, which can fit within housing 12, to an extended position, such that antenna 30 is pulled outward and possibly pulled outside of housing 12 and such that the antenna in the extended position is longer than the antenna in the collapsed position. In one embodiment, when antenna 30 is in its collapsed position, antenna 30 is configured to fit within housing 12 or at least partially embedded within housing 12. For example, antenna 30 may be positioned along bottom edge 36 of circuit board 28 and/or along the bottom edge of housing 12. In one embodiment, antenna 30 is a substantially vertical rod.

Alternatively, accessory 10 may not include antenna 30. In an alternative embodiment, device 26 may include antenna 30.

1.13 Decoder

In one embodiment, accessory 10 may include a decoder (not shown) to facilitate decoding or undoing the encoding of the signal so that the original information can be retrieved, and may be a multiple-input, multiple-output logic circuit. In an alternative embodiment, accessory 10 may operate and function without a decoder. In a further alternative embodiment, software on device 26 and/or on accessory 10 may perform the function of a decoder.

1.14 Accessory Architecture

The details of how the host processor 28 authenticates the accessory 10 as an APPLE®-authorized device and communicates via the accessory 10 protocol are defined in iPod_Accessory_Protocol_Interface_Spec_R38 and iPod_Authentication_Coprocessor_Spec_{—}2.0B_R5, the contents of which both are incorporated herein by reference.

Generally speaking, the host processor 28 may read data from the co-processor 32, such as an APPLE® co-processor, over I²C and then begin the communication process with the device 26, such as an iPHONE®/iPOD®, itself over USB.

2. Operation

As an overview, to operate accessory 10 and view digital TV over a device or cell phone or iPHONE® 26, the user connects the accessory10 to the device or cell phone or iPHONE® 26 by the connector 14, shown in FIG. 2. Chip 22 may detect the signal from the over-the-air ATSC-MH IP signal being broadcast, and hands it off to the ATSC-MH chip 20. The ATSC-MH chip 20 may demodulate the ASTC-MH IP signal into H.264/mpeg-4 video and AAC HE v2 audio streams, and the host processor communicates with the ATSC-MH chip 20. A software client, such as a version of an Aircast Mobile TV application, is used on the device or cell phone or iPHONE® 26 to render the audio/video streams provided by the device 10.

2.1 Data Flow Inside Host Processor

Under normal operation (after accessory 10 initialization), the host processor 28 acts as a bridge between USB-based dock interface 14 of device 26, such as iPHONE®/iPOD®, and the semiconductor chip 20, such as LG2160, over I²C bus.

Data may flow in two directions: device 26, such as iPHONE®, to semiconductor chip 20, such as LG2160, and semiconductor chip 20 to device 26.

2.2 Communication from Device 26 to Semiconductor Chip 20/Tuner 22

In one embodiment, an Aircast Mobile TV application, a program that may be installed on device 26, may send a minimal amount of data to accessory 10. Alternatively, such a program may be installed on accessory 10.

The small amount of data that is sent to accessory 10 may be critical to operation of the accessory 10. These commands shall include:

a. Accessory wake-up

b. Enable/disable tuner

c. Set tuner channel

d. Enable/disable receiver

e. Request signal strength

The details of the packet format are laid out in the Accessory Control IP Packets section (below). From a general standpoint, the host processor 28 may need to implement a minimal IPv4/UDP stack internally to parse incoming UDP packets over USB. Here, the focus is on the responsibilities of the host processor 28 when one of these packets is received.

2.2(a) Accessory Wake-Up Packet

When an accessory 10 wake-up packet is received, the host processor 28 is responsible for sending a default response packet back to device 26, such as the iPHONE® and application. This merely provides a mechanism for the software to see if accessory 10 is responsive. No other action should be taken when this packet is received.

2.2(b) Enable/Disable Tuner Packet

When an enable/disable tuner 22 packet is received, the host processor 28 is responsible for constructing an appropriate I²C command to send to the semiconductor chip 20, such as an LG2160, for forwarding to the slave chip 22, such as a tuner IC, may either enable or disable the chip's 22 low-power mode (if one is available.) Since this may be chip 22 specific, the firmware running on the host processor 28 may be customized appropriately.

Once the command has been received by chip 22, the host processor 22 shall send a confirmation packet back to the device 26 software, such as iPHONE® software, in accordance with the protocol specifications below.

2.2(c) Set Tuner Channel Packet

When a set tuner channel packet is received, the host processor 22 is responsible for constructing an appropriate I²C command to send to the semiconductor chip 20, such as LG2160, for forwarding to the slave tuner IC may set the current tuner frequency. If the chip 22, such as a tuner IC, expects to be programmed with a raw frequency value versus a channel number, the host processor 28 may have an internal mapping available.

Once the command has been received by the tuner IC, chip 22, such as a tuner IC, the host processor 28 shall send a confirmation packet back to the device 26 software, such as iPHONE® software, in accordance with the protocol specifications below.

The host processor 28 is not responsible for differentiating individual ATSC-MH programs on the same channel. All programs from the same channel are constantly streamed and the device 26 software, such as iPHONE® software, may selectively display the appropriate program.

2.2(d) Enable/Disable Receiver Packet

When an enable/disable receiver packet is received, the host processor 28 is responsible for constructing an appropriate I²C command to place the semiconductor chip 20, such as the LG2160, into low or full-power mode (as appropriate).

Once the command has been received by the receiver IC, the host processor 28 shall send a confirmation packet back to the device 26 software, such as iPHONE® software, in accordance with the protocol specifications below.

2.2(e) Request Signal Strength Packet

When a request signal strength packet is received, the host processor 28 is responsible for constructing an appropriate I²C command to retrieve an absolute signal power or lock indicator from the LG2160.

Once this information has been received back from the semiconductor chip 20, such as the LG2160, the host processor 28 shall send a confirmation packet back to the device 26 software, such as iPHONE® software, in accordance with the protocol specifications below.

2.3 Communication from Semiconductor Chip 20 to Device 26

When an active ATSC-MH channel is locked by the chip 22, such as a tuner IC, and there is an active ATSC-MH stream available, the semiconductor chip 20, such as the LG2160, should begin to blast decoded ATSC-MH information over the I²C to host processor 28 interface. This information may be composed primarily of UDP packets with a specific set of source and destination addresses.

Any such data streaming from semiconductor chip 20, such as the LG2160, should be captured by the host processor 28 and forwarded to the device 26 application, such as the iPHONE application, over the accessory USB interface. This may involve:
1. Caching up to the maximum USB packet size
   a. Encapsulating this data into an accessory protocol compatible USB packet
   b. Sending over the USB interface
2. OR, if less than the maximum USB packet size has been received and a predetermined amount of time, e.g., about 100 ms, has passed
   a. Encapsulate this data into an accessory protocol compatible USB packet, padded to the USB packet size
   b. Sending over the USB interface

3. Accessory 10 and Device 26 Protocol

3.1 Send Direction: Communications from Device 26 to Accessory 10

When sending information from device 26 to accessory 10, communications between the device 26, such as an iPHONE®, and accessory 10 is composed of several dependent layers. At the core, communications may take place over a USB 2.0 link. In one embodiment, to satisfy APPLE® requirements, however, there is an added accessory framework layer through which all communications may take place, which may be the “APPLE USB Accessory Layer,” that may enable the use of APPLE® authentication chips. In alternative embodiments, for other devices 26, such as non-APPLE® smart phones, the “APPLE USB Accessory Layer” (shown below) is removed and without effecting the operation of device 26 and/or accessory 10. Please see the Protocol Stack below regarding the overall design and functionality.

Most audio, video and guide data is sent over an IPv4+UDP layer in ATSC MH and, for the sake of consistency, this follows the same approach for device control and response messages.

In one embodiment, the Protocol Stack is:

| | |
|---|---|
| Enable/Disable Modules | Tuner Commands |

Accessory Control Messages
UDP
IPv4
Apple USB Accessory Layer
USB 2.0

Send direction of the signal may be an emulated IPv4 layer on top of the APPLE® USB accessory interface and/or layer. In one embodiment, the APPLE® USB accessory interface and/or layer is optional. For example, it is possible that when device 26 is not an APPLE® device, the APPLE® USB accessory interface and/or layer may be eliminated.

In order to comply with at least one of APPLE'S® licensing programs, hardware manufacturers may need to install Apple's authentication chips into their hardware. In one embodiment, the APPLE® USB Accessory layer exists to detect the presence of these chips on the device. If the chips are not on the device, then the software layer sends the software application a notification that this hardware is not authorized to work with this device. If the Apple USB accessory layer detects the authentication chip, then no message is sent to the software application on the device, phone and/or iPOD®.

In an alternative embodiment, each specific device 26 includes a device or accessory specific interface and/or layer, which would replace the APPLE® USB accessory interface and/or layer, as shown in the Protocol Stack above.

3.2 Accessory Control IP Packets

Accessory Control IP Packets are UDP packets with a destination address of 0.0.0.0 and destination port of 1000. In one embodiment, all control packets have a payload size of approximately 2 bytes. Byte 1 represents the command type and byte 2 represents the data. In alternative embodiments, control packets may have a different or varying payload size.

Although there may be no other data flowing to accessory 10 or device 26, ideally accessory 10 or device 26 should ignore any UDP packets not specifically addressed to 0.0.0.0 port 1000.

The following sections 3.2(a)-3.2(e) are notifications from the hardware or accessory 10 to device 26. For example, in section 3.2(a), the “wake-up” notification confirms that the hardware or accessory 10 is active and is ready to communicate with device 26.

3.2(a) Wake-Up

Wake-up causes the accessory 10 to send a default response to the device, such as an iPHONE®, in order to ensure active communication.

### Command: 0x00

Data: 0x00 (constant)

3.2(b) Enable/Disable Tuner

Enables or disables the chip 22, such as a tuner IC, to conserve power when not in use.

### Command: 0x01

Data: 0x00 to turn off or 0xff to turn on

3.2(c) Select Tuner Channel

Commands the chip 22, such as a tuner, to tune to the specified channel.

### Command: 0x02

Data: 01 decimal through 70 decimal

3.2(d) Enable/Disable Receiver

Enables or disables the receiver IC to conserve power when not in use.

### Command: 0x03

Data: 0x00 to turn off or 0xff to turn on

3.2(e) Request Signal Strength

Requests a signal strength message from accessory 10.

### Command: 0x04

Data: 0x00 (constant)

3.3 Receive Direction: Communications from Accessory 10 to Device 26

The following sections 3.3(a)-3.3(e) are hardware or accessory 10 notifications.

3.3(a) Protocol Stack

In one embodiment, the Protocol Stack is:

| NRT | | | |
|---|---|---|---|
| OMA | RME | CEA | AFD |
| BCAST | | 708 | |

| | | | | |
|---|---|---|---|---|
| FLUTE | HE | AVC | Module | Tuner |
| | AACv2 | | En/Dis | Tuning |

| | | | | | |
|---|---|---|---|---|---|
| Service | ALC/LCT | Time of | Conditional | RTP/RTCP | HW Control |
| Signaling | | Day | Access | | Receive Dir |

UDP
IPv4
Apple USB Accessory Layer
USB 2.0

Receive direction is an emulated IPv4 layer on top of the APPLE® USB accessory interface. This includes ATSC MH data from semiconductor chip 20, such as an LG2160, as well as control signal responses from accessory 10 itself.

Receive stream may contain:
Raw IPv4 packets from semiconductor chip 20, such as an LG2160, directly wrapped inside APPLE® USB accessory protocol
Accessory control response IP packets wrapped inside APPLE® USB accessory protocol

Raw IPv4 packets may be combined with packets that comply with APPLE® USB accessory protocol.

3.4 Accessory Control Response IP Packets

Accessory Control Response IP Packets are UDP packets with a source address of 0.0.0.0 and destination port of 1000. The software may ignore UDP packets originating from an address other than 0.0.0.0 port 1000. In one embodiment, all control packets have a payload size of approximately 2 bytes. Byte 1 represents the response type and byte 2 represents the data. In alternative embodiments, control packets may have a different or varying payload size.

3.4 (a) Wake-Up Confirm

### Response Type: 0x00

Data: 0x00 through 0xff representing firmware version

3.4 (b) Enable/Disable Tuner Confirm

### Response Type: 0x01

Data: 0x00 (constant)

3.4 (c) Select Tuner Channel Confirm

### Response Type: 0x02

Data: 0x00 (constant)

3.4 (d) Enable/Disable Receiver Confirm

### Response Type: 0x03

Data: 0x00 (constant)

3.4 (e) Request Signal Strength Confirm

### Response Type: 0x04

Data: 0x00 through 0xff (representing relative signal strength in −dbsat)

4. Software Side Data Receive Handler Implementation

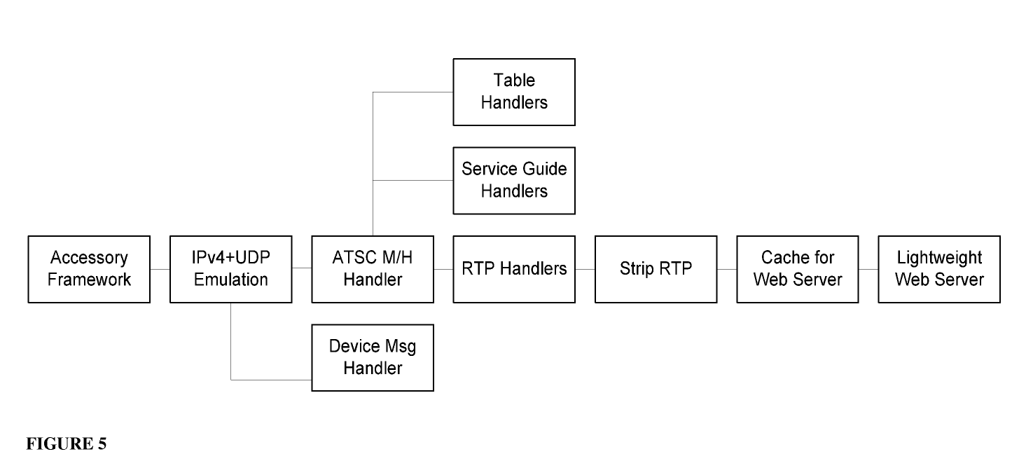

As shown in FIG. 5, the Aircast Mobile TV application implements accessory 10 framework event handlers for receiving data. From there, data is passed to a basic IPv4+UDP emulation class where packets are re-assembled and identified based upon address and port number.

Depending upon identification, data is passed to either the ATSC MH handler module or the device message handler. The device message handler primarily takes care of low-level accessory communications.

The ATSC MH handler further identifies packets by address and port on a per-channel basis. Initially the software may have no awareness of the meaning of most packets until a service mapping table packet is received. This may feed back to the ATSC MH handler allowing us to gain more useful information such as service availability (digital channels), program information and even being able to access video and audio data.

RTP (Real-Time Transport Protocol) is designed to provide end-to-end network transport functions for applications transmitting real-time data, such as audio, video, or simulation data, over multicast or unicast network services. This protocol adds timing and sequencing of the IP packets that are transmitted and/or received by computers or devices.

Once a proper RTP stream is identified, packets are stripped of RTP headers and cached into the device's memory for consumption by the lightweight web server portion of the device's media Framework.

Each mobile device 26 may have a media framework as a part of its respective software operating system. This framework is the software architecture that may dictate and support how multimedia is supported and displayed on the device. Since most smart phones access the internet, most of them have lightweight web servers integrated into the media framework in order to stream content (such as YouTube) from the internet onto the device.

In one embodiment, the lightweight web server potion of the device's media Framework is APPLE'S® Media Framework on the iPHONE®, such that this web server services range may request from the APPLE® Media Framework once a user chooses to view a particular channel. The oldest RTP packets are discarded as new AV data is available.

Additionally, service and program table data is cached for use by the application. The service table allows the application to display all the available digital channels from a particular frequency whereas the program table allows the application to populate the on-screen program guide.

It should be understood, of course, that the foregoing relates to exemplary embodiments of the invention and that modifications may be made without departing from the spirit and scope of the invention as set forth in the following claims.

What is claimed is:

1. An accessory to provide at least one of television and video streams to a mobile device, comprising
a circuit board having a semiconductor chipset, a tuner chipset and a host processor;
a battery; and
a connector capable of attaching said circuit board to a connector of the mobile device.

2. An accessory according to claim 1, further comprising a housing configured to house at least one of said circuit board, said semiconductor chipset, said RF tuner chipset, said host processor, said battery and said accessory connector.

3. An accessory according to claim 1, wherein said host processor is configured to package user datagram protocol (UDP) packets from said semiconductor chipset into a universal serial bus (USB)-based port.

4. An accessory according to claim 1, wherein said host processor is comprises at least one integrated I²C interface and at least one USB interface.

5. An accessory according to claim 1, further comprising an authentication co-processor configured to communicate with said host processor.

6. An accessory according to claim 1, further comprising an antenna, and wherein said accessory connector is a male connector and wherein said mobile device connector is a female connector.

7. An accessory according to claim 1, wherein said mobile device is at least one of a cell phone, a smart phone, a laptop computer, a portable digital video disc (DVD) player, a car stereo, and a global positioning system.

8. An accessory according to claim 1, wherein said semiconductor chipset is an ATSC-MH semiconductor chipset and said tuner chipset is an RF tuner chipset.

9. An accessory according to claim 8, wherein a single chipset includes both said ATSC-MH semiconductor chipset and said RF tuner chipset.

10. An accessory according to claim 1 wherein said host processor is configured to be a bridge between said mobile device and said semiconductor chipset.

11. A method of viewing at least one of television and videos on a mobile device, said method comprising:
detecting a digital television signal with a tuner chipset;
transmitting a signal to a semiconductor chipset;
demodulating and communicating a signal to a host processor; and
communicating a signal to a mobile device for viewing.

12. A method according to claim 11, wherein said communicating step further comprises communicating a signal to a port of the mobile device.

13. A method according to claim 11, further comprising transmitting a signal between the host processor and an authentication co-processor.

14. A method according to claim 11, further comprising rendering a signal viewable with a software client on the mobile device.

15. A method according to claim 11, further comprising packaging UDP packets for transmission to a USB-based port.

16. A method according to claim 11, wherein said step of communicating a signal further comprises using at least one wireless modem (WIFI) to stream TV signal packets to a WIFI-enabled device.
